(19) United States
(12) Patent Application Publication
(10) Pub. No.: US 2018/0358620 A1
(43) Pub. Date: Dec. 13, 2018

(54) ANODE ELECTRODE INCLUDING DOPED ELECTRODE ACTIVE MATERIAL AND ENERGY STORAGE DEVICE INCLUDING SAME

(71) Applicant: AQUION ENERGY LLC, Pittsburgh, PA (US)

(72) Inventors: Cory O'NEIL, San Diego, CA (US); Jen-Hsien YANG, San Diego, CA (US); Marissa CALDWELL, San Diego, CA (US); Bin LI, San Diego, CA (US); Jay WHITCARE, Pittsburgh, PA (US); Sneha SHANBHAG, Pittsburgh, PA (US); Wei WU, Pittsburgh, PA (US)

(21) Appl. No.: 15/781,100

(22) PCT Filed: Dec. 6, 2016
(86) PCT No.: PCT/US16/65133

§ 371 Date: Jun. 1, 2018

Related U.S. Application Data
(60) Provisional application No. 62/263,902, filed on Dec. 7, 2015.

(51) Int. Cl. H01M 4/58; H01M 10/36; H01M 4/485; H01M 4/505; H01M 4/66

(52) U.S. Cl. CPC H01M 4/5825; H01M 10/36; C01B 25/45; H01M 4/505; H01M 4/663; H01M 4/485

(57) ABSTRACT

An energy storage device includes a cathode electrode, an electrolyte, and an anode electrode including sodium titanium phosphate having a NASICON structure doped with zinc or a combination of zinc with at least one of calcium and magnesium.

### FIELD

The present invention is directed to anode electrodes including doped electrode active materials and energy storage devices including the same.

### BACKGROUND

Small renewable energy harvesting and power generation technologies (such as solar arrays, wind turbines, micro sterling engines, and solid oxide fuel cells) are proliferating, and there is a commensurate strong need for intermediate size secondary (rechargeable) energy storage capability. Energy storage batteries for these stationary applications typically store between 1 and 50 kWh of energy (depending on the application) and have historically been based on the lead-acid (Pb acid) chemistry. The batteries typically comprise a number of individual cells connected in series and parallel to obtain the desired system capacity and bus voltage.

For vehicular and stationary storage applications, it is not unusual to have batteries with bus voltages in the hundreds or thousands of volts, depending on application. In these cases, where many units are connected electrically in series, there is typically an inherent need for these cells to be as similar to each other as possible. In the event that the cells are not similar enough, a cell-level monitoring and controlling circuit is commonly necessary. If some set of cells in a string of cells have lower charge capacity than others in the same string, the lower capacity cells will reach an overcharge/undercharge condition during full discharge or charge of the string. These lower capacity cells will be de-stabilized (typically due to electrolyte corrosion reactions), resulting in diminished lifetime performance of the battery. This effect is common in many battery chemistries and is seen prominently in the Li-ion battery and in the supercapacitor pack. In these systems, costly and intricate cell-level management systems are needed if the cells are not produced to exacting (and expensive) precision.

### SUMMARY

Various embodiments of the present disclosure provide an anode electrode for an energy storage device comprising a doped active material represented by a formula ATi_{2-X}M_{X}(PO₄)₃, wherein A comprises at least 51 atomic percent sodium and 0 to 49 atomic percent alkali metals other than sodium, X ranges from about 0.1 to about 0.6, and M is selected from at least one of Mg, Ca, Mn, Mo, Nb, Ni, W, Zn, Zr, Al, Ge, and Si.

Various embodiments of the present disclosure provide a method of making an anode electrode for an energy storage device comprising combining a dopant selected from at least one of elemental Mg, Ca, Mn, Mo, Nb, Ni, W, Zn, Zr, Al, Ge, and Si, an oxide thereof or a hydroxide thereof with titanium, sodium and phosphate precursor materials, heating the combined dopant and precursor materials to form a doped sodium titanium phosphate material, and providing the doped sodium titanium phosphate material into an anode electrode of the energy storage device.

Various embodiments of the present disclosure provide an energy storage device, comprising a cathode electrode, an electrolyte; and an anode electrode comprising sodium titanium phosphate having a NASICON structure doped with zinc or a combination of zinc with at least one of calcium and magnesium.

### BRIEF DESCRIPTION OF THE DRAWINGS

FIG. 1 illustrates an electrochemical cell according to an embodiment of the present disclosure.

FIG. 2 is a schematic illustration of an electrochemical cell according to an embodiment of the present disclosure. The electrochemical cell may be stacked in a bipolar or prismatic stack configuration.

FIG. 3 is a schematic illustration of an electrochemical device comprising a bipolar stack of electrochemical cells according to an embodiment of the present disclosure.

FIG. 4A illustrates an electrochemical energy storage system according to an embodiment of the present disclosure.

FIG. 4B illustrates an electrochemical energy storage system according to another embodiment.

FIG. 5 is a plot of battery capacity as a function of charge/discharge cycles.

FIG. 6A is a plot of cell potential (in volts) versus energy (in units of Wh/kg of electrode active carbon material or in units of Wh/liter of anode electrode volume).

FIG. 6B is a plot of cell potential (in volts) versus specific capacity (in units of mAH/g).

FIG. 6C is a Ragone plot of energy density versus power density for a prior art cell.

FIG. 7A is a plot of anode specific capacitance (in F/g) versus electrode potential (in units of volts versus SME) for an activated carbon anode.

FIG. 7B is a plot of anode specific capacitance (in F/g) versus electrode potential (in units of volts versus SME) for an activated carbon anode with nickel hydroxide hydrogen storage material added to the anode surface.

FIG. 8A is a plot of cell potential (in volts) versus anode capacity (in mAh) to illustrate a voltage profile of a test cell made with composite activated carbon/NTP anode and a λ-MnO₂ cathode in 1 M Na₂SO₄.

FIG. 8B is a plot of discharge capacity (in Ah) versus cycle number to illustrate the cycle life stability of the test cell of FIG. 8A. Cycles 1-10 and 15 to 42 were performed at a C/2 rate, while cycles 11 to 14 were performed at a C/10 rate.

FIG. 9A is a chart illustrating the capacity retention of battery cells including LFP cathodes and anodes including NTP doped with 0.1 and 0.3 M Eq. amounts of elemental zinc, zinc hydroxide, and zinc oxide.

FIGS. 9B and 9C are graphs illustrating the capacity and capacity retention of an undoped NTP control battery cell and battery cells including anodes including NTP doped with 0.3 M Eq. amounts of elemental zinc, zinc hydroxide, and zinc oxide, as shown in FIG. 9A.

FIG. 10A is a graph illustrating capacities of an exemplary battery cell including NTP doped with 0.3 M Eq. of zinc, and a process control battery cell that included undoped NTP.

FIG. 10B is a graph illustrating the capacity retention of the battery cells of FIG. 10A.

FIGS. 11A and 11B are graphs illustrating the capacity and capacity retention of battery cells including NTP doped with from 0.1 to 0.5 M Eq. amounts of zinc.

FIGS. 12A and 12B are graphs illustrating the capacity and capacity retention of battery cells including NTP doped with from 0.4 M Eq. of zinc, wherein the anodes underwent a second anneal at time periods ranging from about 0.5 hours to 6 hours, at a temperature ranging from about 850° C. to about 900° C.

FIGS. 13A and 13B are graphs illustrating the capacity and capacity retention of battery cells including anodes including Zn doped NTP (NaTi_{1.7}Zn_{0.3}(PO₄)₃) and Zn, Mg co-doped NTP (NaTi_{1.4}Zn_{0.3}Mg_{0.3}(PO₄)₃).

FIGS. 14A and 14B are graphs illustrating the capacity and capacity retention of a battery cell including an anode including NTP doped with Zn only (0.4 M Eq.), and battery cells including anodes including NTP co-doped with Zn (0.4 M Eq.) and either 0.1, 0.2, or 0.3 M Eq. of Ca.

FIG. 15 is a graph illustrating capacity retention as a function of cycle number for a battery cell including an anode including NTP doped with Zn (0.2 M Eq.) and for a battery cell including an anode including undoped NTP.

### DETAILED DESCRIPTION

It would be very useful to have batteries that can be built with cells that have a higher cell-to-cell charge storage capacity variation without sacrificing the integrity of the pack. The inventor has discovered an aqueous electrolyte electrochemical cell that is able to self-regulate using internal electrochemical reactions upon overcharge. This self-regulation allows for high voltage strings of cells to be manufactured with a high tolerance for cell-to-cell charge capacity variation. Preferably, but not necessarily, the system lacks a cell level voltage monitoring and current control circuit (also known as a cell-level battery management system, or BMS). Thus, the cell level voltage is not monitored or controlled.

Without being bound by any particular theory, the inventor believes that the mechanism of self-regulation is the local electrolysis of the aqueous electrolyte that takes place at the anode electrode. As electrolysis occurs, a small amount of hydrogen is generated along with OH⁻ species. The OH⁻ species locally increase the pH, thereby pushing the voltage stability window of electrolyte in the immediate vicinity of the anode to a lower value. This subsequently eliminates the continued evolution of hydrogen.

It is believed that at least a portion of the hydrogen species formed on charging of the cell is stored in, on and/or at the anode electrode of the cell during the period of overcharge. For brevity, the hydrogen species formed on charging of the cell and stored in, on and/or at the anode electrode will be referred to as “anode stored hydrogen” hereafter. It is believed that the hydrogen may be stored by being adsorbed (e.g., by van der Waals forces) and/or chemically bound (e.g., by covalent bonding) to the anode electrode surface and/or may be stored in the bulk of the activated carbon anode, for example by intercalation into the activated carbon lattice, adsorption to sidewalls of the activated carbon pores and/or by chemical bonding to the sidewalls of activated carbon pores. As used herein, intercalation includes ion insertion into the lattice of any host material and is not limited to insertion into layered materials only. Likewise, deintercalation is used to mean extraction of the ion from any host material into the electrolyte. It is also possible that the hydrogen may be stored at the anode as a capacitive or pseudocapacitive double layer at (i.e., near) the anode surface. Preferably, a majority of the hydrogen species (e.g., at least 51%, such as 60-99%, including 70-90%) is stored in and/or at the anode electrode. Any remaining generated hydrogen species may evaporate from the cell as hydrogen gas.

If desired, any suitable hydrogen storage material may be added to the activated carbon anode material to increase the amount of anode stored hydrogen. Non-limiting examples of hydrogen storage materials include materials which chemically and/or physically store hydrogen, such as metal hydride materials (e.g., MgH₂, NaAlH₄, LiAlH₄, LiH, LaNi₅H₆, TiFeH₂, palladium hydride, etc.), metal hydroxide materials, (e.g., nickel hydroxide), metal boro-hydrides (e.g., LiBH₄, NaBH₄, etc.), nanostructured carbon (e.g., carbon nanotubes, buckyballs, buckypaper, carbon nanohorms, etc.), hollow glass microspheres, etc. The hydrogen storage material may be added only to the surface of the activated carbon anode and/or it may be added to the bulk of the anode by being mixed and pressed with the active carbon. The hydrogen storage material may be added to the anode electrode in a range of at least 0.1 mass %, such as 0.5 to 10 mass %, for example 1-2 mass % of the anode.

When the battery is allowed to discharge, it is believed that at least a portion of the anode stored hydrogen is released from the anode and is consumed/reacted (i.e., recombines) with local OH⁻ to re-form water, or instead diffuses to the cathode side of the cell, where it can be similarly consumed. Preferably, a majority of the released anode stored hydrogen (e.g., at least 51%, such as 60-99%, including 70-90%) is reacted with local OH⁻ to re-form water. Any remaining released anode stored hydrogen may evaporate from the cell as hydrogen gas.

The inventor has discovered that the use of an anode electrode of a material with a high overpotential for hydrogen evolution from water, such as carbon, combined with the local electrolysis and recombination of the aqueous electrolyte allows for an electrode environment that is highly tolerant to overcharge.

An embodiment of the invention includes an electrochemical storage device that includes cells electrically connected in series having a wider as-manufactured cell-to-cell variation in charge storage capacity than conventional charge storage devices. In this embodiment, cells with a lower charge storage capacity in the same string of cells charge to higher potentials during cycling. When this happens, the effect described above is believed to occur with no long-term detriment to the cell string.

In an embodiment, the electrochemical storage device is a hybrid electrochemical energy storage system in which the individual electrochemical cells include a pseudocapacitive or double-layer capacitor electrode (e.g., anode) coupled with an active electrode. In these systems, the capacitor electrode stores charge through a reversible nonfaradiac reaction of alkali (e.g., Li, Na, K, etc.) or Ca cations on the surface of the electrode (double-layer) and/or pseudocapacitance, while the active electrode undergoes a reversible faradic reaction in a transition metal oxide or a similar material that intercalates (i.e., inserts) and deintercalates (i.e., extracts) alkali or Ca cations similar to that of a battery.

An example of a Li-based system has been described by Wang, et al., which utilizes a spinel structure LiMn₂O₄ battery electrode, an activated carbon capacitor electrode, and an aqueous Li₂SO₄ electrolyte. Wang, et al., Electrochemistry Communications, 7:1138-42(2005). In this system, the negative anode electrode stores charge through a reversible nonfaradiac reaction of Li-ion on the surface of an activated carbon electrode. The positive cathode electrode utilizes a reversible faradiac reaction of Li-ion intercalation/deintercalation in spinel LiMn₂O₄. A different system is disclosed in U.S. patent application Ser. No. 12/385,277, filed Apr. 3, 2009, hereby incorporated by reference in its entirety. In this system, the cathode electrode comprises a material having a formula AₓM_{y}O_{z}. A is one or more of Li, Na, K, Be, Mg, and Ca, x is within a range of 0 to 1 before use and within a range of 0 to 10 during use. M comprises any one or more transition metals, y is within a range of 1 to 3 and z is within a range of 2 to 7. The anode electrode comprises activated carbon and the electrolyte comprises SO₄²⁻, NO₃₋, ClO₄³⁻, PO₄³⁻, CO₃²⁻, Cl⁻, or OH⁻ anions. Preferably, the cathode electrode comprises a doped or undoped cubic spinel λ-MnO₂-type material or a NaMn₉O₁₈ tunnel structured orthorhombic material, the anode electrode comprises activated carbon and the electrolyte comprises Na₂SO₄ solvated in water.

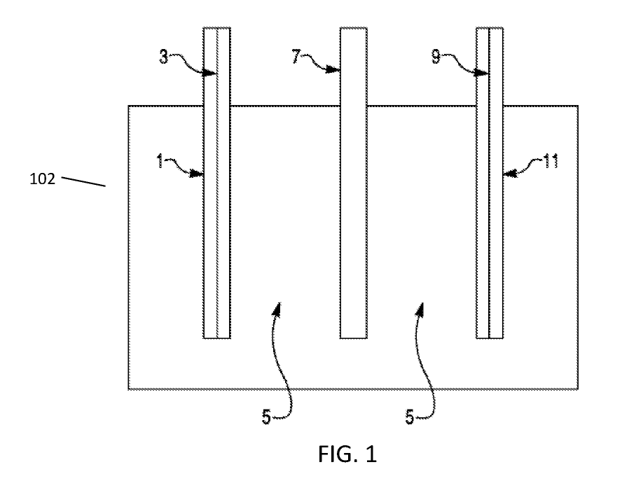

FIG. 1 is a schematic illustration of an exemplary electrochemical cell 102 according to an embodiment. The cell 102 includes a cathode side current collector 1 in contact with a cathode electrode 3. The cathode electrode 3 is in contact with an aqueous electrolyte solution 5, which is also in contact with an anode electrode 9. The cell 102 also includes a separator 7 located in the electrolyte solution 5 at a point between the cathode electrode 3 and the anode electrode 9. The anode electrode is also in contact with an anode side current collector 11. In FIG. 1, the components of the exemplary cell 102 are shown as not being in contact with each other. The cell 102 was illustrated this way to clearly indicate the presence of the electrolyte solution 5 relative to both electrodes. However, in actual embodiments, the cathode electrode 3 is in contact with the separator 7, which is in contact with the anode electrode 9.

In this embodiment, the cell 102 is “anode limited”. That is, the charge storage capacity of the anode electrode 9 is less than that of the cathode electrode 3. The charge storage capacity of an electrode is the product of the mass of the electrode and the specific capacity (in units of Ah/kg) of the electrode material. Thus, in an anode limited cell, the mass of the active cathode material multiplied by the usable specific capacity of the cathode material is greater than the mass of the active anode material multiplied by the useable specific capacity of the anode material. Preferably, the storage capacity of the anode electrode 9 available before water begins electrolysis at the anode electrode/electrolyte interface is 50-90%, such as 75-90% of the charge storage capacity of the cathode electrode 3.

In a preferred embodiment, the cell is an unbalanced cell in which the product of the specific capacity of the anode and the load of the anode is less than the product of the specific capacity of the cathode and the load of the cathode. For example, the cathode product may be at least 20% greater, such as 50-500%, for example 100-200% greater than the anode product. Thus, the capacity (in the units of mAh) of the anode is lower (such as at least 50-500% lower) than that of the cathode.

The unbalanced cell causes the water to electrolyze at the anode and the generated hydrogen ions to become anode stored hydrogen, when the anode potential is below the electrolysis potential of water. This is not necessarily an “overcharge” condition because the battery may be designed to be operated at this low anode potential.

Preferably, the anode electrode 9 is made from a material that is corrosion resistant (resistant to the hydrogen formed by electrolysis) at the charging voltage as will be discussed below.

A method according to an embodiment includes charging the energy storage system 100 at a voltage 1.5 times greater and/or 0.8 volts higher than a voltage at which electrolysis of the water at the anode electrode of the cells is initiated, without inducing corrosion of the anode electrode material.

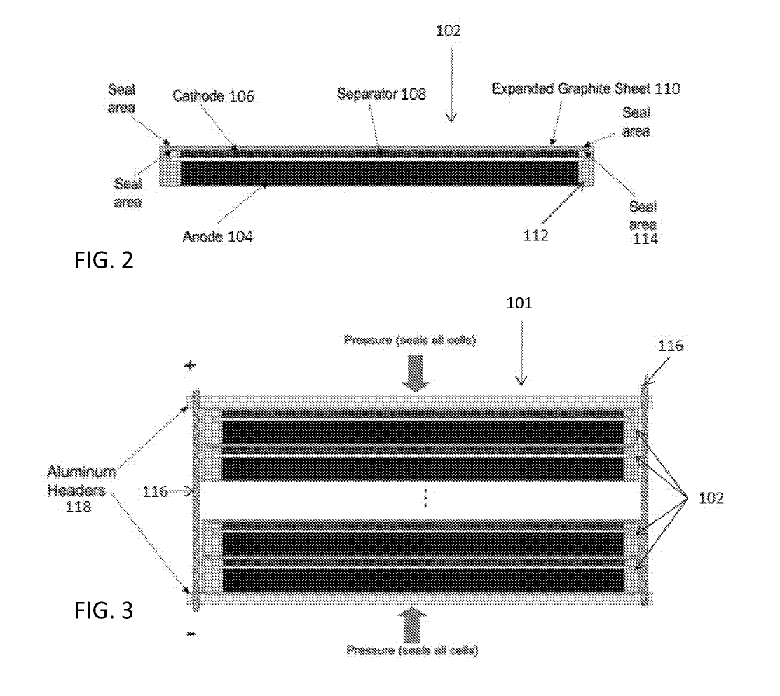

FIG. 2 illustrates another embodiment of an electrochemical cell 102. The electrochemical cell 102 includes an anode electrode 104, a cathode electrode 106 and a separator 108 between the anode electrode 104 and the cathode electrode 106. The electrochemical cell 102 also includes an electrolyte located between the anode electrode 104 and the cathode electrode 106. In an embodiment, the separator 108 may be porous with electrolyte located in the pores. The electrochemical cell 102 may also include a graphite sheet 110 that acts as a current collector for the electrochemical cell 102. Preferably, the graphite sheet 110 is densified. In an embodiment, the density of the graphite sheet 110 is greater than 0.6 g/cm³. The graphite sheet 110 may be made from, for example, exfoliated graphite. In an embodiment, the graphite sheet 110 may include one or more foil layers. Suitable materials for the anode electrode 104, the cathode electrode 106, the separator 108 and the electrolyte are discussed in more detail below.

The anode electrode 104, the cathode electrode 106, the separator 108 and the graphite sheet current collector 110 may be mounted in a frame 112 which seals each individual cell. The frame 112 is preferably made of an electrically insulating material, for example, an electrically insulating plastic or epoxy. The frame 112 may be made from preformed rings, poured epoxy or a combination of the two. In an embodiment, the frame 112 may comprise separate anode and cathode frames. In an embodiment, the graphite sheet current collector 110 may be configured to act as a seal 114 with the frame 112. That is, the graphite sheet current collector 110 may extend into a recess in the frame 112 to act as the seal 114. In this embodiment, the seal 114 prevents electrolyte from flowing from one electrochemical cell 102 to an adjacent electrochemical cell 102. In alternative embodiments, a separate seal 114, such as a washer or gasket, may be provided such that the graphite sheet current collector does not perform as a seal.

In an embodiment, the electrochemical cell is a hybrid electrochemical cell. That is, the cathode electrode 106 in operation reversibly intercalates (i.e., inserts) alkali metal cations and the anode electrode 104 comprises a capacitive electrode which stores charge through either (1) a reversible nonfaradiac reaction of alkali metal cations on a surface of the anode electrode or (2) a pseudocapacitive electrode which undergoes a partial charge transfer surface interaction with alkali metal cations on a surface of the anode electrode.

Individual device components may be made of a variety of materials as follows.

### Anode

The anode may, in general, comprise any material capable of reversibly storing Na-ions (and/or other alkali or alkali earth ions) through surface adsorption/desorption (via an electrochemical double layer reaction and/or a pseudocapacitive reaction (i.e. partial charge transfer surface interaction)) and be corrosion/hydrogen resistant in the desired voltage range. In an embodiment, the anodes are made of activated carbon (which is corrosion free; that is, not damaged by evolved hydrogen). Preferably, the anode electrode comprises high surface area (e.g., activated) carbon that has been modified to have more than 120 F/g (e.g., 120 to 180 F/g) in 1 M Na₂SO₄ under anodic biasing conditions. Preferably, the activated carbon anode is pseudocapacitive and is configured to operate in a voltage range of −1 to 0.8 volts SHE. Alternative anode materials include graphite, mesoporous carbon, carbon nanotubes, disordered carbon, Ti-oxide (such as titania) materials, V-oxide materials, phospho-olivine materials, other suitable mesoporous ceramic materials, and combinations thereof.

Optionally, the anode electrode may be in the form of a composite anode comprising activated carbon, a high surface area conductive diluent (such as conducting grade graphite, carbon blacks, such as acetylene black, non-reactive metals, and/or conductive polymers), a binder, such as PTFE, a PVC-based composite (including a PVC—SiO₂ composite), cellulose-based materials, PVDF, other non-reactive non-corroding polymer materials, or a combination thereof, plasticizer, and/or a filler. The composite anode electrode, as with a single material anode electrode, should be corrosion/hydrogen resistant in the desired voltage range. In an embodiment, the anode electrode comprises an alkali titanate compound that reversibly interacts with alkali or alkali earth ions via a pseudocapacitive or intercalative (i.e., insertion) reaction mechanism, such as sodium or lithium titanate. The alkali titanate may be, for example, in the form of nanocrystals on the surface of the anode or intercalated (inserted) into the anode.

### Composite Anode

In another embodiment, the anode electrode comprises both an ion intercalation (i.e., insertion) material and a pseudocapacitive material. For example, the anode electrode may comprise a mixture of a ceramic material which in operation reversibly intercalates (i.e., inserts) alkali metal cations from the electrolyte and a pseudocapacitive material which in operation undergoes a partial charge transfer surface interaction with alkali metal cations on a surface of the anode electrode. The alkali metal cations, such as sodium, lithium, potassium or a combination thereof are deintercalated (i.e., extracted) from the cathode into the electrolyte and then intercalated (i.e., inserted) into the anode ceramic material during the cell discharging cycle. Alkali metal cations (e.g., Na cations) are deintercalated from the anode into the electrolyte during cell charge cycle (and are then intercalated into the cathode electrode).

Any suitable ceramic intercalation materials and pseudocapacitive materials may be used. Preferably, the pseudocapacitive material comprises the activated carbon described above or another suitable pseudocapacitive material, such as a ceramic pseudocapacitive material or a mixture thereof. Optionally, the activated carbon may be subject to a nitric, sulfuric, hydrochloric, phosphoric or combinations thereof acid surface modification treatment to improve its specific capacitance and pseudocapacitive behavior, as described in U.S. published patent application US 2012/0270102 A1, which is incorporated herein by reference in its entirety.

Preferably, the ceramic intercalation material comprises a NASICON material. As described by Vijayan et al., in chapter 4 of the “Polycrystalline Materials—Theoretical and Practical Aspects” book (Z. Zachariev, ed.), NASICON materials generally have the following formula: AₓB_{y}(PO₄)₃, where A is an alkali metal ion, B is a multivalent metal ion (e.g., transition metal ion), P is at least 80 atomic percent phosphorus (e.g., 80-100 at % phosphorus and remainder (if any) transition metal(s), such as vanadium), O is oxygen and 0.95≤x≤3.05, and 1.95≤y≤2.05. The charge compensating A cations occupy two types of sites, M1 and M2 (1:3 multiplicity), in the interconnected channels formed by corner sharing PO₄ tetrahedra and BO₆ octahedra. M1 sites are surrounded by six oxygen atoms and located at an inversion center and M2 sites are symmetrically distributed around three-fold axis of the structure with tenfold oxygen coordination. In three-dimensional frame-work of NASICON, numerous ionic substitutions are allowed at various lattice sites. Generally, NASICON structures crystallize in thermally stable rhombohedral symmetry and have a formula AB₂(PO₄)₃. Preferably, A comprises Li, Na and/or K, and B comprises Ti, Mn and/or Fe. However, members of A₃M₂(PO₄)₃ family (where A=Li, Na and M=Cr, Fe) crystallize in monoclinic modification of Fe₂(SO₄)₃-type structure and show reversible structural phase transitions at high temperatures.

According to some embodiments, the anode intercalation material has a formula AB_{2±δ1}(PO₄)_{3±δ2}, where A comprises at least 50 atomic percent Na, such as 50-100 atomic percent Na, including 75-100 atomic percent Na with the remainder (if any) being Li. Preferably, B comprises at least 50 atomic percent Ti, such as 50-100 atomic percent Ti, including 75-100 atomic percent Ti with the remainder (if any) being Mn or a combination of Mn and Fe. The symbols δ1 and δ2 allow for a slight deviation from the strict 1:2:3 atomic ratio of alkali/transition metal/phosphate in the material (i.e., a non-stoichiometric material is permitted). δ1 and δ2 may each independently vary between zero and 0.05, such as between zero and 0.01. One preferred material is NaTi₂(PO₄)₃ (“NTP”).

Specifically, the present inventors have found that creating a composite anode of NTP and surface modified activated carbon can display a marked increase in energy density and specific capacity (mAh/g) compared to just the activated carbon alone. Without wishing to be bound by a specific theory, it is believed that the increase in energy density and specific capacity may be due to the increased physical density of the composite compared to activated carbon alone. Furthermore this composite has been found to be completely stable through many cycles due to the stability of the carbon at voltage extremes, compared to the lack of stability typically exhibited by an electrode consisting only of NTP.

The NASICON material, such as the NTP material, can be made in a variety of ways, such as a solid state method in which starting material powders are mixed and then heated (e.g., to decompose the initial reactants, calcine and/or sinter the material). For example, the starting material powders may comprise sodium carbonate, anatase or rutile phase of TiO₂, and NH₄H₂PO₄, for the NTP NASICON material. The resulting NASICON material may be ground or milled into a powder and optionally heated again (e.g., calcined and/or sintered).

The NASICON material powder is then mixed with the pseudocapacitive material, such as activated carbon, and optionally a binder and/or other additive described above (including the hydrogen storage material(s) described above), and then densified to form a composite anode. This results in a composite anode which is a mixture of the NASICON and activated carbon materials. However, in alternative embodiments, the composite anode may comprise discreet regions of the NASICON material in an activated carbon matrix or discreet regions of activated carbon in the NASICON matrix, depending on the ratio of the two materials.

In one embodiment the composite anode material structure contains a blend of NaTi₂(PO₄)₃ (“NTP”) and activated carbon (“AC”), where the blend ranges from 1:9 to 9:1 mass ratio of NTP:AC, such as a 1:1 ratio. The electrode may be used in a poly-ionic aqueous electrolyte energy storage device (e.g., battery or hybrid device) where the anode is a free standing electrode on a current collector and the anode contains a porous structure that is filled with electrolyte that is an aqueous solution of an alkali-bearing salt with a pH ranging from 4 to 10. As used herein, “poly-ionic” means usable with one or more different ions. However, the storage device may use only one ion (e.g., sodium) or a combination of ions (e.g., Na and Li) that are stored at and/or in the anode electrode. In one embodiment, the composite anode is used in an “anode limited” cell described above in which the charge storage capacity of the anode electrode is less than that of the cathode electrode. However, in another embodiment, the composite anode may be used in cells which are not anode limited.

The composite anode displays a specific capacity value of at least 50 mAh per gram of active material, such as 50 mAh/g to 100 mAh/g, including greater than 70 mAh/g, preferably 75 mAh/g to 100 mAh/g when cycled through a useful voltage range.

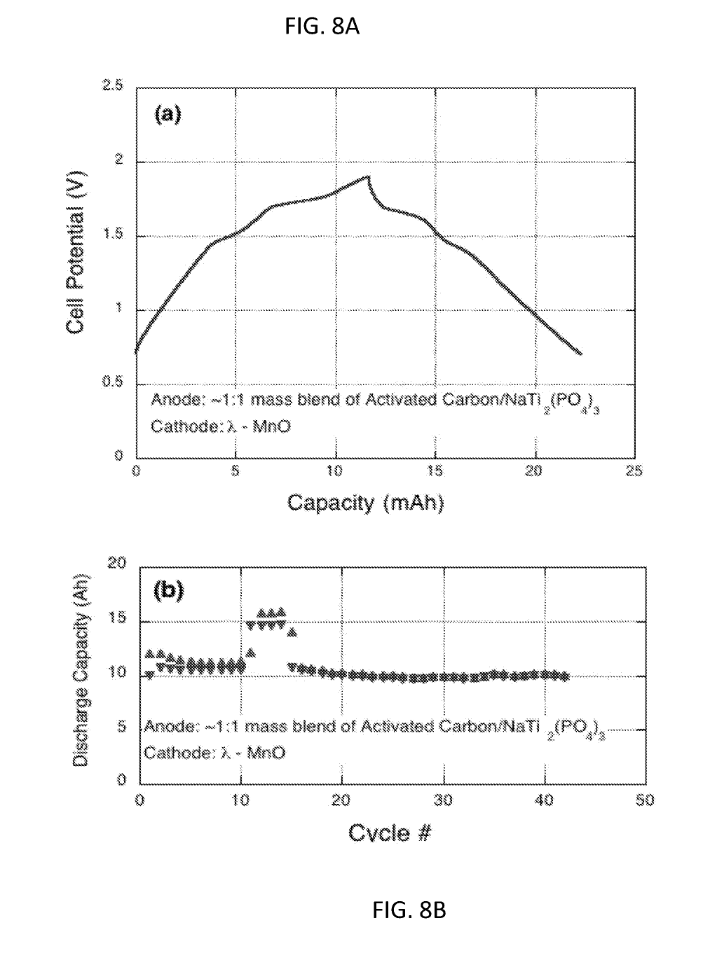

FIG. 8A shows a typical charge/discharge curve of a cell made with a LiMn₂O₄ (λ-MnO₂) cathode and a composite anode that is comprised of a blend of activated carbon and the NTP material (approximately 1:1 mass ratio). The electrolyte was 1 M Na₂SO₄. The result shows several key improvements over the state of the art pure AC or NASICON anode. The bulk of the energy is delivered over a more shallow voltage swing compared to that found in devices with just a pure activated carbon anode material or an anode containing pure activated carbon and a similar cathode. Specifically, in this case, most of the embodied energy is delivered between 1.9 and 1 V, representing a 2:1 voltage swing, which is well suited to most off the shelf large format inverter systems.

FIG. 8B shows the cycle life stability of the test cell described above with respect to FIG. 8A. Cycles 1-10 and 15 to 42 were done at a C/2 rate, while cycles 11 to 14 were done at a C/10 rate. No long term loss in function has been observed. Remarkably, even under slow cycling, there is no capacity fade observed (the capacity changed less than 5% from cycles 15-42 over more than 25 cycles and less than 1% from cycles 20-42 over more than 20 cycles). This is an advance from previously published work showing the performance of the NTP material in aqueous electrolyte environments, where significant capacity fade is observed.

If the activated carbon is not mixed with the NTP material, it has been found to be less stable as a functional material. Without being limited to a particular theory, the present inventors believe that hydrogen is evolved at extreme states of charge, such as at an overcharge condition, and that the activated carbon mixed with NTP serves several purposes during use, including protecting NTP from corrosion by gettering hydrogen groups that evolve during charging, and also providing a stable material during overcharge conditions described elsewhere herein (e.g., at a voltage above 1.6 V). Thus, it is believed that hydrogen species (e.g., protons or other hydrogen species) are stored pseudocapacitively at the composite anode electrode, while the alkali ions (e.g., Na or Na+Li) are stored by intercalation or a combination of intercalation and pseudocapacitive mechanisms in and/or at the anode electrode. For example, during electrochemical use, it is believed that the alkali ion intercalates and deintercalates in/out of the NTP through a potential range of −1 and −1.5 V vs. a standard mercury/mercury sulfate reference electrode. The activated carbon may also perform a charge storage function throughout the range of use via electrochemical double layer capacitance (EDLC) and/or pseudocapacitance.

In summary, performance of the composite anode shows a specific capacity greater than 70 mAh/g in a relevant voltage range and excellent stability during use. This is much in contrast to the performance of the pure NTP material, which has been shown to degrade significantly over even tens of lower rate, long duration deep discharges in similar electrolyte environments. It is believed that the presence of the activated carbon local to the NTP materials absorbs species that otherwise might contribute to the corrosion and loss of function of the material during electrochemical use.

According to various embodiments, the present inventors have discovered that doping the NASICON material included in the above anodes, e.g., doping the NTP material, may unexpectedly provide for improved cycle life of a battery including such an anode. Such a doped NTP material may be included as an active electrode material in any of the above anodes. For example, a composite anode may include a doped NTP material, activated carbon, and a binder, as described above.

In particular, the Ti and/or P sites of the NTP material may be doped with an alkali earth metal, a transition metal, and/or a P-block element (i.e., element from Groups 13 to 18 (also known as Groups IIIA to VIIIA) of the Periodic Table of Elements). For example, the P sites of the NTP material may be doped with Ge, Si, B, Sb, oxides thereof, hydroxides thereof, or a combination thereof. In one embodiment even if an oxide or hydroxide is used to dope the NTP material rather than an elemental dopant, the final NTP material in the battery cell after all of the annealing step may comprise the doping element (Ge, Si, B and/or Sb) rather than its oxide or hydroxide. According to some embodiments, the Ti sites of the NTP material may be doped with at least one of Mg, Ca, Mn, Mo, Nb, Ni, W, Zn, Zr, Al, Ge, Si, oxides thereof and hydroxides thereof. In one embodiment even if an oxide or hydroxide is used to dope the NTP material rather than an elemental dopant, the final NTP material in the battery cell after all of the annealing step may comprise the doping element (Mg, Ca, Mn, Mo, Nb, Ni, W, Zn, Zr, Al, Ge and/or Si) rather than its oxide or hydroxide. According to some embodiments, both the P and Ti sites may be doped.

According to some embodiments, the doped NTP material may be a represented by the following Formula 1:

ATi_{2-X}M_{X}(PO₄)₃; Formula 1:

With regard to Formula 1, A comprises at least 51 atomic percent sodium, such as 60 to 100 atomic percent sodium, and 0 to 49 atomic percent other alkali metals, such as 0 to 40 atomic percent lithium. M may Mg, Ca, Mn, Mo, Nb, Ni, W, Zn, Zr, Al, Ge, and/or Si, X may be greater than 0 and less than 1. For example, X may range from about 0.05 to about 0.7, from about 0.1 to about 0.6, from about 0.15 to about 0.5, or from about 0.2 to about 0.45.

In another embodiment, M_{X} comprises at least two elements M′ and N and the doped active material (e.g., doped NTP) is represented by the following formula 2:

ATi_{2-(Z+Y)}M′_{Z}N_{Y}(PO₄)₃, Formula 2:

In formula 2, Z ranges from about 0.1 to about 0.565 and Y ranges about 0.035 to about 0.3, M′ and N comprise different elements selected from Mg, Ca, Mn, Mo, Nb, Ni, W, Zn, Zr, Al, Ge and Si, and A comprises at least 51 atomic percent sodium, such as 60 to 100 atomic percent sodium, and 0 to 49 atomic percent other alkali metals, such as 0 to 40 at. % lithium. According to various embodiments, Z may be greater than 0 and less than 0.5. For example, Z may range from about 0.05 to about 0.45, According to various embodiments, Y may be greater than 0 and less than 1. For example, Y may range from about 0.025 to about 0.4, such as from about 0.035 to about 0.3, from about 0.01 to about 0.3, or from about 0.05 to about 0.2. According to some embodiments, Na may be at least partially substituted with Li.

According to various embodiments, M may comprise Zn and N may comprise Ca and/or Mg. In other embodiments, M may comprise Zn and N may comprise Ca and/or Mg. As such, the doped NTP material may be represented by the following Formula 3:

ATi_{2-(X+Y)}Zn_{X}(Ca,Mg)_{Y}(PO₄)₃ Formula 3:

With regard to Formula 3, A comprises at least 51 atomic percent sodium, such as 60 to 100 atomic percent sodium, and 0 to 49 atomic percent other alkali metals, such as 0 to 40 at. % lithium. X and Y may have values as described above. For example, X may range from about 0.2 to about 0.45, and Y may range from about 0.05 to about 0.2, according to some embodiments.

For example, the material may comprise NASICON structure sodium titanium phosphate (i.e., NTP) doped with zinc or a combination of zinc with at least one of calcium and magnesium. In one non-limiting embodiment, the final anode active NASICON structure sodium titanium phosphate anode material may include only the sodium, titanium, phosphorus and oxygen of the NASICON structure and a dopant selected from one or more zinc, silicon, calcium, magnesium or lithium, and exclude all other elements or compounds above an unavoidable trace impurity. Thus, the final material may exclude halogen (e.g., fluorine) atoms and/or hydroxyl compounds even if a zinc hydroxyl compound is used as a starting material for doping NTP. In another non-limiting embodiment, the dopant atoms (e.g., zinc, silicon, calcium, magnesium and/or other dopant atoms listed above) may be present in the NASICON sodium titanium phosphate material throughout the thickness of the anode electrode (i.e., through the bulk of the anode) rather than just being present in a shell or coating on a surface of the anode electrode.

In another embodiment, while not wishing to be bound by a particular theory, it is believed that alkaline earth metal dopants, such as Ca and/or Mg for example, may be preferentially located on the Na site and/or on the Ti site, while the transition metal dopants may be preferentially located on the Ti site. Further, metalloids such as Si and Ge, may be preferentially located on the P site. However, it may be possible for any of the dopants to be located on any of the sites in the lattice and/or on interstitial sites in the lattice.

Thus, according to this embodiments, the doped NTP material may be a represented by the following Formula 4 which includes alkali earth metal(s) on the Na site:

Na_{1-X}D_{X}Ti_{2-Y}M_{Y}(P_{1-Z}E_{Z}O₄)₃.

In Formula 4, X ranges from 0 to about 0.49, Y ranges from 0 to about 0.6, Z ranges from 0 to about 0.4, such as 0.05 to 0.4, X+Y+Z>0, D comprises Li, an alkaline earth metal (e.g., Ca and/or Mg), or a combination thereof, M comprises an alkaline earth metal, a transition metal, a P-block metal element, or any combination thereof, and E comprises a metalloid, such as Si and/or Ge. In this embodiment, both X and Y may be greater than zero. Z may be zero when X and Y are greater than zero, and X and Y may each be zero when Z is greater than zero. Alternatively, all three of X, Y and Z may be greater than zero.

For example, for silicon doped NTP, E comprises silicon, and Z ranges from about 0.1 to about 0.4. In contrast, for Zn and alkali earth metal doped NTP, M is selected from the group consisting of Zn, Ca, Mg, or any combination thereof, and D is selected from the group consisting of Ca, Mg, Li, or any combination thereof. If the alkali earth metals are located on the Na lattice site, then D comprises at least one of Ca and Mg, M consists essentially of Zn, X>0, and Y ranges from about 0.2 to about 0.45.

Alternatively, two or more of alkali (e.g., Li) and alkali earth metal (e.g., Ca and/or Mg) dopants may be located on the Na site in the lattice. For example, all three of Li, Mg and Ca may be located on the Na site in the lattice. In this embodiment, the doped NTP material may be a represented by the following Formula 5:

Na_{1-X-R}D1_{X}D2_{R}Ti_{2-Y}M_{Y}(P_{1-Z}E_{Z}O₄)₃

In Formula 5, X ranges from 0.05 to about 0.49, R ranges from 0.05 to 0.49, Y ranges from 0 to about 0.6, X+R<0.5, X+Y+R>0, Z ranges from 0 to about 0.4, such as 0.05 to 0.4, D1 and D2 comprise two different dopants selected from Li and an alkaline earth metal (e.g., Ca and/or Mg), M comprises an alkaline earth metal, a transition metal, a P-block element, or any combination thereof, and E comprises a metalloid, such as Si and/or Ge.

### Cathode

Any suitable material comprising a transition metal oxide, sulfide, phosphate, or fluoride can be used as active cathode materials capable of reversible alkali and/or alkali earth ion, such as Na-ion intercalation/deintercalation. Materials suitable for use as active cathode materials in embodiments of the present invention preferably contain alkali atoms, such as sodium, lithium, or both, prior to use as active cathode materials. It is not necessary for an active cathode material to contain Na and/or Li in the as-formed state (that is, prior to use in an energy storage device). However, for devices in which use a Na-based electrolyte, Na cations from the electrolyte should be able to incorporate into the active cathode material by intercalation during operation of the energy storage device. Thus, materials that may be used as cathodes in embodiments of the present invention comprise materials that do not necessarily contain Na or other alkali in an as-formed state, but are capable of reversible intercalation/deintercalation of Na or other alkali-ions during discharging/charging cycles of the energy storage device without a large overpotential loss.

In embodiments where the active cathode material contains alkali-atoms (preferably Na or Li) prior to use, some or all of these atoms are deintercalated during the first cell charging cycle. Alkali cations from a sodium based electrolyte (overwhelmingly Na cations) are re-intercalated during cell discharge. This is different than nearly all of the hybrid capacitor systems that call out an intercalation electrode opposite activated carbon. In most systems, cations from the electrolyte are adsorbed on the anode during a charging cycle. At the same time, the counter-anions, such as hydrogen ions, in the electrolyte intercalate into the active cathode material, thus preserving charge balance, but depleting ionic concentration, in the electrolyte solution. During discharge, cations are released from the anode and anions are released from the cathode, thus preserving charge balance, but increasing ionic concentration, in the electrolyte solution. This is a different operational mode from devices in embodiments of the present invention, where hydrogen ions or other anions are preferably not intercalated into the cathode active material. The examples below illustrate cathode compositions suitable for Na intercalation. However, cathodes suitable for Li, K or alkali earth intercalation may also be used.

Suitable active cathode materials may have the following general formula during use: AₓM_{y}O_{z}, where A is Na or a mixture of Na and one or more of Li, K, Be, Mg, and Ca, where x is within the range of 0 to 1, inclusive, before use and within the range of 0 to 10, inclusive, during use; M comprises any one or more transition metal, where y is within the range of 1 to 3, inclusive; preferably within the range of 1.5 and 2.5, inclusive; and O is oxygen, where z is within the range of 2 to 7, inclusive; preferably within the range of 3.5 to 4.5, inclusive.

In some active cathode materials with the general formula AₓM_{y}O_{z}, Na-ions reversibly intercalate/deintercalate during the discharge/charge cycle of the energy storage device. Thus, the quantity x in the active cathode material formula changes while the device is in use.

In some active cathode materials with the general formula AₓM_{y}O_{z}, A comprises at least 50 at % of at least one or more of Na, K, Be, Mg, or Ca, optionally in combination with Li; M comprises any one or more transition metal; O is oxygen; x ranges from 3.5 to 4.5 before use and from 1 to 10 during use; y ranges from 8.5 to 9.5 and z ranges from 17.5 to 18.5. In these embodiments, A preferably comprises at least 51 at % Na, such as at least 75 at % Na, and 0 to 49 at %, such as 0 to 25 at %, Li, K, Be, Mg, or Ca; M comprises one or more of Mn, Ti, Fe, Co, Ni, Cu, V, or Sc; x is about 4 before use and ranges from 0 to 10 during use; y is about 9; and z is about 18.

In some active cathode materials with the general formula AₓM_{y}O_{z}, A comprises Na or a mix of at least 80 atomic percent Na and one or more of Li, K, Be, Mg, and Ca. In these embodiments, x is preferably about 1 before use and ranges from 0 to about 1.5 during use. In some preferred active cathode materials, M comprises one or more of Mn, Ti, Fe, Co, Ni, Cu, and V, and may be doped (less than 20 at %, such as 0.1 to 10 at %; for example, 3 to 6 at %) with one or more of Al, Mg, Ga, In, Cu, Zn, and Ni.

General classes of suitable active cathode materials include (but are not limited to) the layered/orthorhombic NaMO₂ (birnessite), the cubic spinel based manganate (e.g., MO₂, such as λ-MnO₂ based material where M is Mn, e.g., LiₓM₂O₄ (where 1≤x<1.1) before use and Na₂Mn₂O₄ in use), the Na₂M₃O₇ system, the NaMPO₄ system, the NaM₂(PO₄)₃ system, the Na₂MPO₄F system, the tunnel-structured orthorhombic NaM₉O₁₈, or materials with the Prussian blue type crystal structure having a formula KMFe(CN)₆, where M in all formulas comprises at least one transition metal. Typical transition metals may be Mn or Fe (for cost and environmental reasons), although Co, Ni, Cr, V, Ti, Cu, Zr, Mo, Nb, Ni, W, Zn, Mo (among others), or combinations thereof, may be used to wholly or partially replace Mn, Fe, or a combination thereof. In embodiments of the present invention, Mn is a preferred transition metal.

However, in other embodiments, the material may lack Mn. For example, for materials having a Prussian blue type crystal structure, such as the Prussian blue hexacyanometallate crystal structure, M may be copper and the material may comprise copper hexacyanoferrate, KMFe(CN)₆. Other metal-hexacyanoferrate materials may also be used, where the M is one or more of some combination of Cu, Ni, Fe, Ti, Mn, or other transition metals, such as Zn and/or Co. Examples of these materials are described in C. Wessells et al., Nature Communications 2, article number 550, published Nov. 22, 2011 (doi:10.1038/ncomms1563) and Y. Lu et al., Chem. Commun., 2012, 48, 6544-6546, both of which are incorporated herein by reference in their entirety.

In some embodiments, cathode electrodes may comprise multiple active cathode materials, either in a homogenous or near homogenous mixture or layered within the cathode electrode.

In some embodiments, the initial active cathode material comprises NaMnO₂ (birnassite structure) optionally doped with one or more metals, such as Li or Al.

In some embodiments, the initial active cathode material comprises λ-MnO₂ (i.e., the cubic isomorph of manganese oxide) based material, optionally doped with one or more metals, such as Li or Al.

In these embodiments, cubic spinel λ-MnO₂ may be formed by first forming a lithium containing manganese oxide, such as lithium manganate (e.g., cubic spinel LiMn₂O₄) or non-stoichiometric variants thereof. In embodiments which utilize a cubic spinel λ-MnO₂ active cathode material, most or all of the Li may be extracted electrochemically or chemically from the cubic spinel LiMn₂O₄ to form cubic spinel λ-MnO₂ type material (i.e., material which has a 1:2 Mn to O ratio, and/or in which the Mn may be substituted by another metal, and/or which also contains an alkali metal, and/or in which the Mn to O ratio is not exactly 1:2). This extraction may take place as part of the initial device charging cycle. In such instances, Li-ions are deintercalated from the as-formed cubic spinel LiMn₂O₄ during the first charging cycle. Upon discharge, Na-ions and/or Li-ions from the electrolyte intercalate into the cubic spinel λ-MnO₂. As such, the formula for the active cathode material during operation is Na_{y}LiₓMn₂O₄ (optionally doped with one or more additional metal as described above, preferably Al), with 0<x<1, 0<y<1, and x+y≤1.1. Preferably, the quantity x+y changes through the charge/discharge cycle from about 0 (fully charged) to about 1 (fully discharged). However, values above 1 during full discharge may be used. Furthermore, any other suitable formation method may be used. Non-stoichiometric LiₓMn₂O₄ materials with more than 1 Li for every 2 Mn and 4O atoms may be used as initial materials from which cubic spinel λ-MnO₂ may be formed (where 1≤x<1.1 for example). Thus, the cubic spinel λ-manganate may have a formula Al_{z}LiₓMn_{2-z}O₄ where 1≤x<1.1 and 0≤z<0.1 before use, and Al_{z}LiₓNa_{y}Mn₂O₄ where 0≤x<1.1, 0≤x<1, 0≤x+y<1.1, and 0≤z<0.1 in use (and where Al may be substituted by another dopant).

In some embodiments, the initial cathode material comprises Na₂Mn₃O₇, optionally doped with one or more metals, such as Li or Al.

In some embodiments, the initial cathode material comprises Na₂FePO₄F, optionally doped with one or more metals, such as Li or Al.

In some embodiments, the cathode material comprises orthorhombic NaM₉O₁₈, optionally doped with one or more metals, such as Li or Al. This active cathode material may be made by thoroughly mixing Na₂CO₃ and Mn₂O₃ to proper molar ratios and firing, for example at about 800° C. The degree of Na content incorporated into this material during firing determines the oxidation state of the Mn and how it bonds with O₂ locally. This material has been demonstrated to cycle between 0.33<x<0.66 for NaₓMnO₂ in a non-aqueous electrolyte. Alternatively, the cathode material comprises LiMn₂O₄ and the electrolyte comprises Li₂SO₄.

Optionally, the cathode electrode may be in the form of a composite cathode comprising one or more active cathode materials, a high surface area conductive diluent (such as conducting grade graphite, carbon blacks, such as acetylene black, non-reactive metals, and/or conductive polymers), a binder, a plasticizer, and/or a filler. Exemplary binders may comprise polytetrafluoroethylene (PTFE), a polyvinylchloride (PVC)-based composite (including a PVC-SiO₂ composite), cellulose-based materials, polyvinylidene fluoride (PVDF), hydrated birnassite (when the active cathode material comprises another material), other non-reactive non-corroding polymer materials, or a combination thereof. A composite cathode may be formed by mixing a portion of one or more preferred active cathode materials with a conductive diluent, and/or a polymeric binder, and pressing the mixture into a pellet. In some embodiments, a composite cathode electrode may be formed from a mixture of about 50 to 90 wt % active cathode material, with the remainder of the mixture comprising a combination of one or more of diluent, binder, plasticizer, and/or filler. For example, in some embodiments, a composite cathode electrode may be formed from about 80 wt % active cathode material, about 10 to 15 wt % diluent, such as carbon black, and about 5 to 10 wt % binder, such as PTFE.

One or more additional functional materials may optionally be added to a composite cathode to increase capacity and replace the polymeric binder. These optional materials include but are not limited to Zn, Pb, hydrated NaMnO₂ (birnassite), and Na₄Mn₉O₁₈ (orthorhombic tunnel structure). In instances where hydrated NaMnO₂ (birnassite) and/or hydrated Na_{0.44}MnO₂ (orthorhombic tunnel structure) is added to a composite cathode, the resulting device has a dual functional material composite cathode. A cathode electrode will generally have a thickness in the range of about 40 to 800 μm.

### Current Collectors

In embodiments of the present invention, the cathode and anode materials may be mounted on current collectors. For optimal performance, current collectors are desirable that are electronically conductive and corrosion resistant in the electrolyte (aqueous Na-cation containing solutions, described below) at operational potentials.

For example, an anode current collector should be stable in a range of approximately −1.2 to −0.5 V vs. a standard Hg/Hg₂SO₄ reference electrode, since this is the nominal potential range that the anode half of the electrochemical cell is exposed during use. A cathode current collector should be stable in a range of approximately 0.1 to 0.7 V vs. a standard Hg/Hg₂SO₄ reference electrode.

Suitable uncoated current collector materials for the anode side include stainless steel, Ni, NiCr alloys, Al, Ti, Cu, Pb and Pb alloys, refractory metals, and noble metals.

Suitable uncoated current collector materials for the cathode side include stainless steel, Ni, NiCr alloys, Ti, Pb-oxides (PbOₓ), and noble metals.

Current collectors may comprise solid foils or mesh materials.

Another approach is to coat a metal foil current collector of a suitable metal, such as Al, with a thin passivation layer that will not corrode and will protect the foil onto which it is deposited. Such corrosion resistant layers may be, but are not limited to, TiN, CrN, C, CN, NiZr, NiCr, Mo, Ti, Ta, Pt, Pd, Zr, W, FeN, CoN, etc. These coated current collectors may be used for the anode and/or cathode sides of a cell. In one embodiment, the cathode current collector comprises Al foil coated with TiN, FeN, C, or CN. The coating may be accomplished by any method known in the art, such as but not limited to physical vapor deposition such as sputtering, chemical vapor deposition, electrodeposition, spray deposition, or lamination.

### Electrolyte

Embodiments of the present invention provide a secondary (rechargeable) energy storage system which uses a water-based (aqueous) electrolyte, such as an alkali based (e.g., Li and/or Na-based) or alkaline earth based aqueous electrolyte. Use of Na allows for use of much thicker electrodes, much less expensive separator and current collector materials, and benign and more environmentally friendly materials for electrodes and electrolyte salts. Additionally, energy storage systems of embodiments of the present invention can be assembled in an open-air environment, resulting in a significantly lower cost of production.

Electrolytes useful in embodiments of the present invention comprise a salt dissolved fully in water. For example, the electrolyte may comprise a 0.1 M to 10 M solution of at least one anion selected from the group consisting of SO₄²⁻, NO₃⁻, ClO₄⁻, PO₄³⁻, CO₃²⁻, CH₃COO⁻, Cl⁻, and/or OH⁻. Thus, Na cation containing salts may include (but are not limited to) Na₂SO₄, NaNO₃, NaClO₄, Na₃PO₄, Na₂CO₃, NaCl, and NaOH, or a combination thereof.

In some embodiments, the electrolyte solution may be substantially free of Na. In these instances, cations in salts of the above listed anions may be an alkali other than Na (such as Li or K) or alkaline earth (such as Ca, or Mg) cation. Thus, alkali other than Na cation containing salts may include (but are not limited to) Li₂SO₄, LiNO₃, LiClO₄, Li₃PO₄, Li₂CO₃, LiCl, and LiOH, K₂SO₄, KNO₃, KClO₄, K₃PO₄, K₂CO₃, KCl, and KOH. Exemplary alkaline earth cation containing salts may include CaSO₄, Ca(NO₃)₂, Ca(ClO₄)₂, CaCO₃, and Ca(OH)₂, MgSO₄, Mg(NO₃)₂, Mg(ClO₄)₂, MgCO₃, and Mg(OH)₂. Electrolyte solutions substantially free of Na may be made from any combination of such salts. In other embodiments, the electrolyte solution may comprise a solution of a Na cation containing salt and one or more non-Na cation containing salt.

Molar concentrations preferably range from about 0.05 M to 3 M, such as about 0.1 to 1 M, at 100° C. for Na₂SO₄ in water depending on the desired performance characteristics of the energy storage device, and the degradation/performance limiting mechanisms associated with higher salt concentrations. Similar ranges are preferred for other salts.

A blend of different salts (such as a blend of a sodium containing salt with one or more of an alkali, alkaline earth, lanthanide, aluminum and zinc salt) may result in an optimized system. Such a blend may provide an electrolyte with sodium cations and one or more cations selected from the group consisting of alkali (such as Li or K), alkaline earth (such as Mg and Ca), lanthanide, aluminum, and zinc cations.

The pH of the electrolyte may be neutral (e.g., close to 7 at room temperature, such as 6.5 to 7.5). Optionally, the pH of the electrolyte may be altered by adding some additional OH—ionic species to make the electrolyte solution more basic, for example by adding NaOH other OH⁻ containing salts, or by adding some other OW concentration-affecting compound (such as H₂SO₄ to make the electrolyte solution more acidic). The pH of the electrolyte affects the range of voltage stability window (relative to a reference electrode) of the cell and also can have an effect on the stability and degradation of the active cathode material and may inhibit proton (H⁺) intercalation, which may play a role in active cathode material capacity loss and cell degradation. In some cases, the pH can be increased to 11 to 13, thereby allowing different active cathode materials to be stable (than were stable at neutral pH 7). In some embodiments, the pH may be within the range of about 3 to 13, such as between about 3 and 6 or between about 8 and 13.

Optionally, the electrolyte solution contains an additive for mitigating degradation of the active cathode material, such as birnassite material. An exemplary additive may be, but is not limited to, Na₂HPO₄, in quantities sufficient to establish a concentration ranging from 0.1 mM to 100 mM.

### Separator

A separator for use in embodiments of the present invention may comprise a woven or non-woven cotton sheet, PVC (polyvinyl chloride), PE (polyethylene), glass fiber or any other suitable material.

FIG. 3 illustrates an exemplary embodiment of an electrochemical energy storage system 100. In this embodiment, the electrochemical energy storage system 100 comprises a bipolar stack 101 of electrochemical cells 102 according to another embodiment. In contrast to conventional stacks of electrochemical cells which include separate anode side and cathode side current collectors, in one embodiment, the bipolar stack 100B operates with a single graphite sheet current collector 110 located between the cathode electrode 106 of one electrochemical cell 102 and the anode electrode 104 of an adjacent electrochemical cell 102. Thus, bipolar stack 100B only uses half as many current collectors as the conventional stack of electrochemical cells.

In an embodiment, the bipolar stack 101 is enclosed in an outer housing 116 and provided with conducting headers 118 on the top and bottom of the bipolar stack 101. The headers 118 preferably comprise a corrosion resistant current collector metal, including but not limited to, aluminum, nickel, titanium and stainless steel. Preferably, pressure is applied to the bipolar stack 101 when assembled. The pressure aids in providing good seals to prevent leakage of electrolyte.

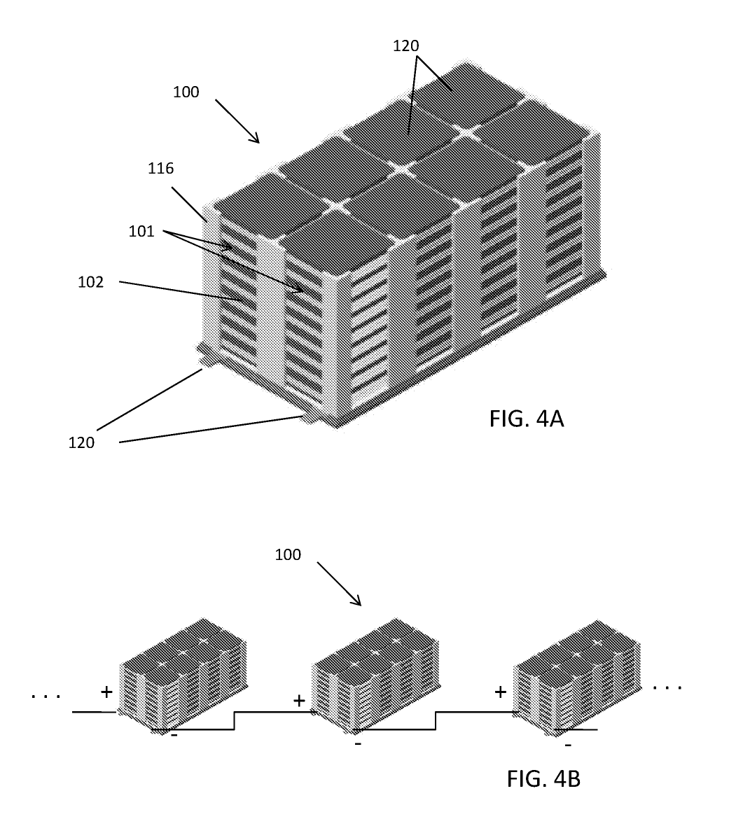

FIG. 4A illustrates an embodiment of an electrochemical energy storage system 100 according to an embodiment. The electrochemical energy storage system 100 includes a stack 101 of cells 102. The stack 101 of cells 102 may include 2, 4, 6, 8, or more cells 102. The stack 101 may then be enclosed in a housing 116. The top and bottom contacts 120 extend out of the housing 116 and provide a path for electricity to flow in and out of the cell 102.

In this embodiment, the electrochemical energy storage system 100 preferably includes multiple stacks 101 of cells 102. As illustrated, the electrochemical energy storage system 100 includes 8 stacks of cells 102, however, any number of stacks 101, such as 1, 2, 3, 4, 5, 6, 7, 8 or 10 may be fabricated. Larger electrochemical energy storage systems 100 having 20, 40, 50, 100 or 1000 stacks may also be fabricated. In an embodiment, all of the cells 102 in a stack 101 are connected in parallel while the stacks 101 are connected to each other in series. In other embodiments, one or more stacks 101 may be connected in parallel. In this manner, high voltages, such as hundreds or thousands of volts can be generated.

FIG. 4B illustrates another embodiment of an electrochemical energy storage system 100. In this embodiment, two or more of the electrochemical energy storage systems 100 illustrated in FIG. 4A are connected in series. In this configuration, very large voltages may be conveniently generated. In an alternative embodiment, two or more of the electrochemical energy storage systems 100 illustrated in FIG. 4A are connected in parallel. In this configuration, large currents may be provided at a desired voltage.

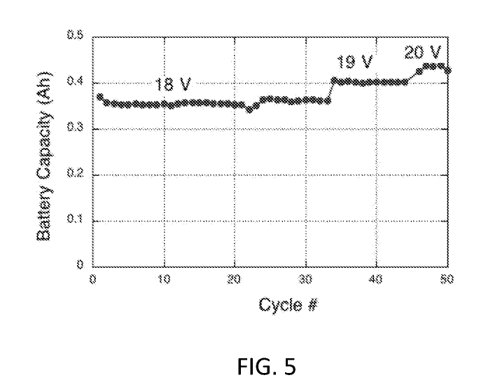

FIG. 5 shows data from a stack 101 of 10 cells 102 made with non-perfectly matched units cycled for many cycles. The cathode electrode 3 was made from λ-MnO₂ and the anode electrode 9 was made from activated carbon. These cells are designed for 0.6 to 1.8V/cell operation. The anode electrode 9 had a charge storage capacity that was 90% of the capacity of the cathode electrode 3. For the first 34 cycles, the stack 101 was charged at 18 volts (1.8 volts/cell). The stack 101 was then charged at 19 volts (1.9 V/cell) for 11 cycles followed by 20 volts (2.0V/cell) for 5 cycles. After 50 cycles, the data show that even though the aqueous cell voltage is higher than the expected stability window of water (1.23 V at 25 C), the stack 101 of cells 102 can be stably cycled. The data show no loss of function (no loss of capacity) through 50 cycles. This cannot be done for cells that are cathode limited (where the overpotential condition manifests at the cathode 3). This is because if the cell 102 was cathode limited, there would be oxygen evolving at the cathode 3 that would contribute to significant active material (metal oxide cathode) corrosion, leading to eventual failure of the cell 102.

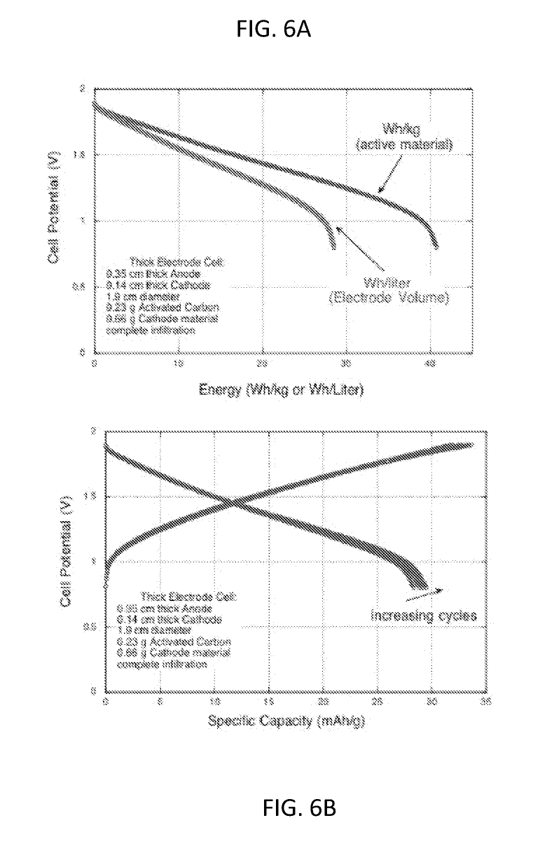

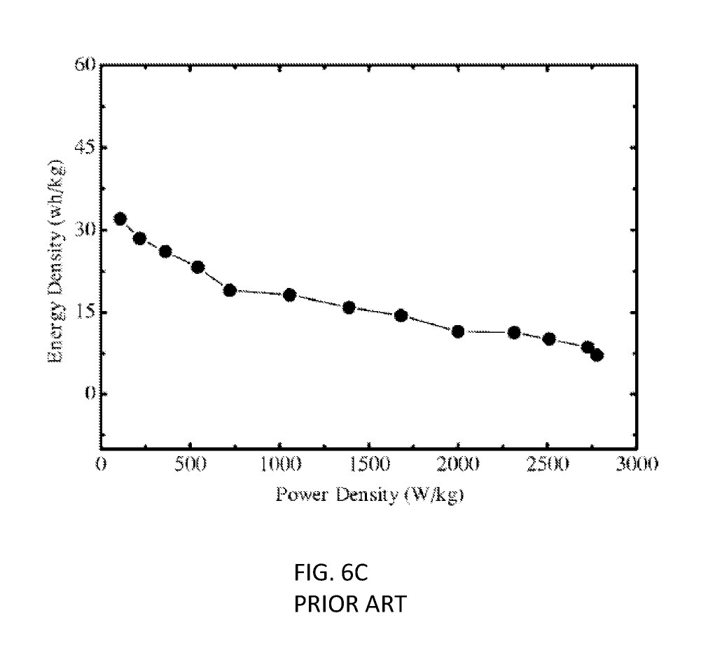

FIGS. 6A and 6B are data plots from a non-limiting, exemplary device according to an embodiment of the invention which illustrate the effect of the anode to cathode mass ratio. In the exemplary cell, the anode active material (i.e., activated carbon) mass is 0.23 g and the cathode active material (i.e., metal oxide) mass is 0.66 g. The weight ratio of the anode to cathode mass is about 1 to 2.8 (i.e., less than 1). The cell dimension is 1.9 cm diameter, 0.35 cm thick anode, and 0.14 cm thick cathode.

As shown in FIG. 6A, this configuration provides over 40 Wh/kg in specific energy and nearly 30 Wh/l in energy density for the electrode stack volume in which packaging is not included. Furthermore, the data in FIG. 6B shows the good stability of the hybrid storage device. The capacity gets better as the device is cycled, which indicates that the electrode materials are not breaking down.

FIG. 6C illustrates a Ragone plot from a prior art device shown in FIG. 6 of an article by Wang et al., Journal of The Electrochemical Society, 153 (2) A450-A454 (2006), in which the best activated carbon anode to LiMn₂O₄ cathode mass ratio was 2:1. The best energy density of this prior art device was just over 30 Wh/kg at similar low rates. Thus, the exemplary device provides about 30% more energy (i.e., 40 vs. 30 Wh/kg) by using the anode stored hydrogen mechanism and an anode : cathode mass ratio of less than 1:1, such as less than 1:2, for example 1:2.5 to 1.4 (e.g., 1:2.8).

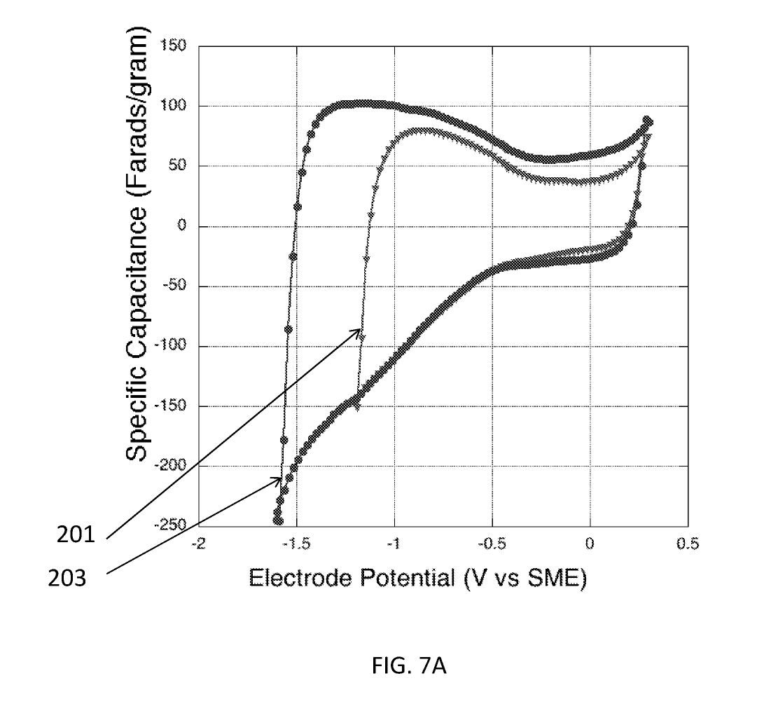

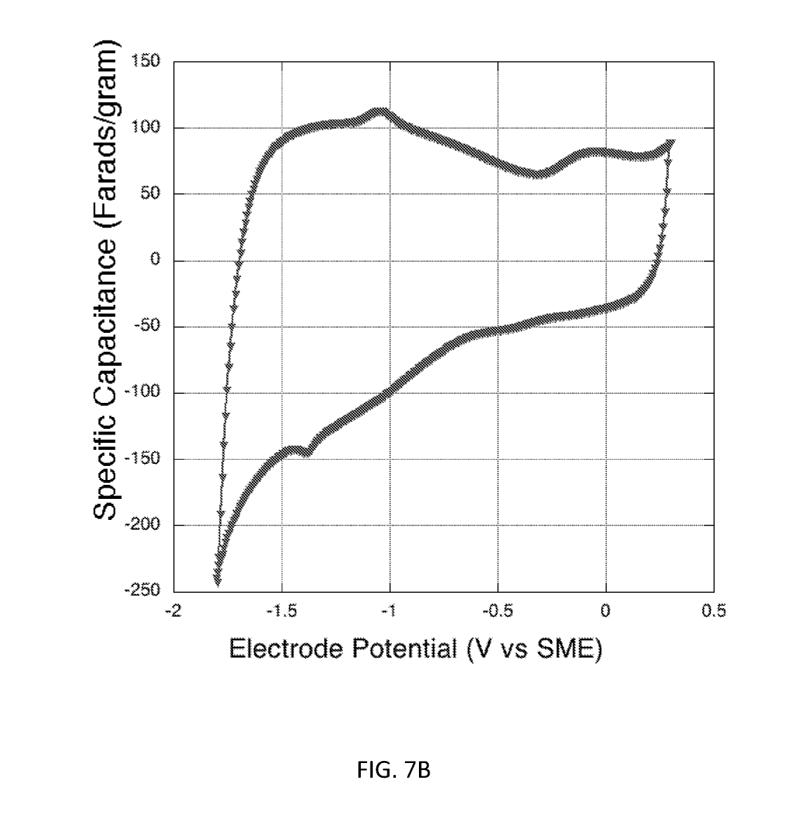

FIG. 7A is a cyclic voltammogram that shows the increase in storage capacitance (in Farads/g) as a result of generating local hydrogen, storing it, and then releasing it. Specifically, plot 201 is a plot of activated carbon cycled to only −1.2 V vs. SME. This is a potential range where little to no hydrogen will be evolved, and the specific capacitance of plot 201 is lower than that for plot 203 which shows the behavior of the carbon when it is taken to −1.6 V vs. SME. In this potential range, hydrogen is evolved and the specific capacitance of the material is increased from a maximum of about 80 F/g to a maximum of over 100 F/g (on the positive or cathodic sweep). The added capacitance is attributed to the storage and subsequent consumption of hydrogen that is generated at the electrode under more extreme potentials. In this non-limiting example, the anode active material is activated carbon, then electrolyte is 1 M aqueous Na₂SO₄, the sweep rate is 5 mV/second, and the reference electrode is Hg/Hg₂SO₄ in sulfuric acid.

FIG. 7B is a cyclic voltammogram similar to that in FIG. 7A, except that the anode includes activated carbon containing 1 mass percent nickel hydroxide (hydrogen storage material) added to the surface of the activated carbon. When this composite anode sample is tested under the same conditions described above with respect to FIG. 7A, good specific capacitance values are observed. Furthermore, distinct features on the plot are believed to be consistent with hydrogen storage mechanism associated with Ni—OH compounds. This is believed to be evidence that hydrogen is being evolved, stored and released at the expected potential ranges in this neutral pH solution of 1 M Na₂SO₄.

Thus, it is believed that FIGS. 7A and 7B serve as examples that show the anode stored hydrogen mechanism functioning in the same environment created in the hybrid device within the anode electrodes, such as during the above described overcharge condition. Furthermore, the anode stored hydrogen mechanism is more pronounced for long charge/discharge cycles (e.g., >1 hour cycles, such as 2-12 hour cycle). In contrast, this mechanism may not be observed in the quick “supercapacitor” type cycles (e.g., a few seconds to a few minutes) of prior art hybrid devices, such as the 200-920 second cycles of the Wang et al. article mentioned above.

### Doped NTP Exemplary Embodiments

Anodes including a doped NTP material were fabricated by loading TiO₂, NaH₂PO₄, and (NH₄)₂HPO₄ (e.g., titanium, sodium and phosphate precursor materials), carbon and a dopant precursor(s) described above into a milling vessel, in amount configured to produce the desired stoichiometric ratios. The milling vessel was then sealed under an argon atmosphere, and the materials were milled for about 6 hours. The resulting material then underwent a first anneal at about 350° C., for about 1 hour, followed by a second anneal at about 800-900° C., for about 0.5 to 6 hours.

The resulting material was then formulated into electrode films in an about 80:15:5 NTP:PVdF:carbon formulation. The electrode films were then tested in high-throughput battery cells against LiFePO₄ (“LFP”) or LiMn₂O₄ (“LMO”) cathodes. A phosphate to sodium ratio was maintained at about 8:1.

The battery cells were cycled according to the following protocol (where “Cy” means cycle number):
Cy0: 12 h at open circuit voltage (OCV);
Cy1-2: C/5 charge/discharge;
Cy3-4: C/5 charge/1C discharge;
Cy5-6: C/5 charge/discharge;
Cy7-8: 1C charge/C/5 discharge;
Cy9+: 1C charge/discharge; and
Cy100, 200, 300 (every 100 cycles): C/5 charge/discharge.

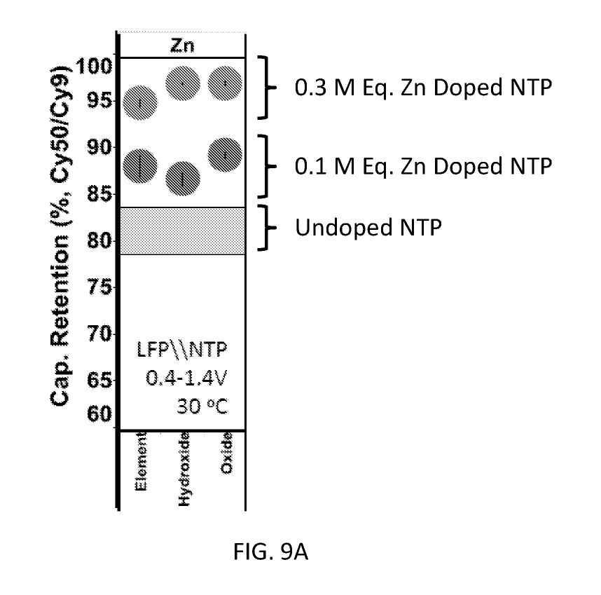

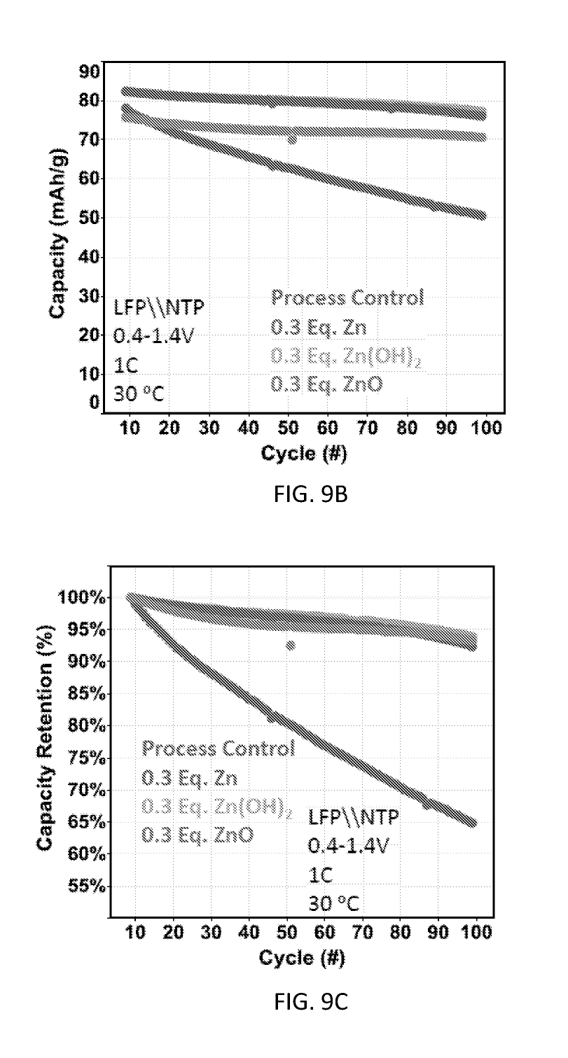

FIG. 9A is a chart illustrating the capacity retention of battery cells including LFP cathodes and anodes including NTP doped with about 0.1 and about 0.3 M Eq. amounts of elemental zinc, zinc hydroxide (Zn(OH)₂), and zinc oxide (ZnO). All conditions were charged balanced, and the vertical lines represent an average synthesis control of +/−1 σ.

As shown in FIG. 9A, all of the zinc doped NTP cells exhibited better capacity retention as compared to the shown capacity retention range of cells including undoped NTP. Further, the 0.3 M Eq. doped cells exhibited between about 95 and 98% capacity retention as a ratio of capacity at cycle 50 to capacity at cycle 9 (Cy50/Cy9).

FIGS. 9B and 9C are graphs illustrating the capacity and capacity retention and cycle life of an undoped NTP control (i.e., comparative example) battery cell and battery cells including anodes including NTP doped with about 0.3 M Eq. amounts of elemental zinc, zinc hydroxide, or zinc oxide, as shown in FIG. 9A. Referring to FIGS. 9B and 9C, it can be seen that the doped NTP provided better capacity and capacity retention than the undoped NTP. Further, it can be seen that the zinc oxide and hydroxide dopants provided better capacity than the elemental zinc dopant.

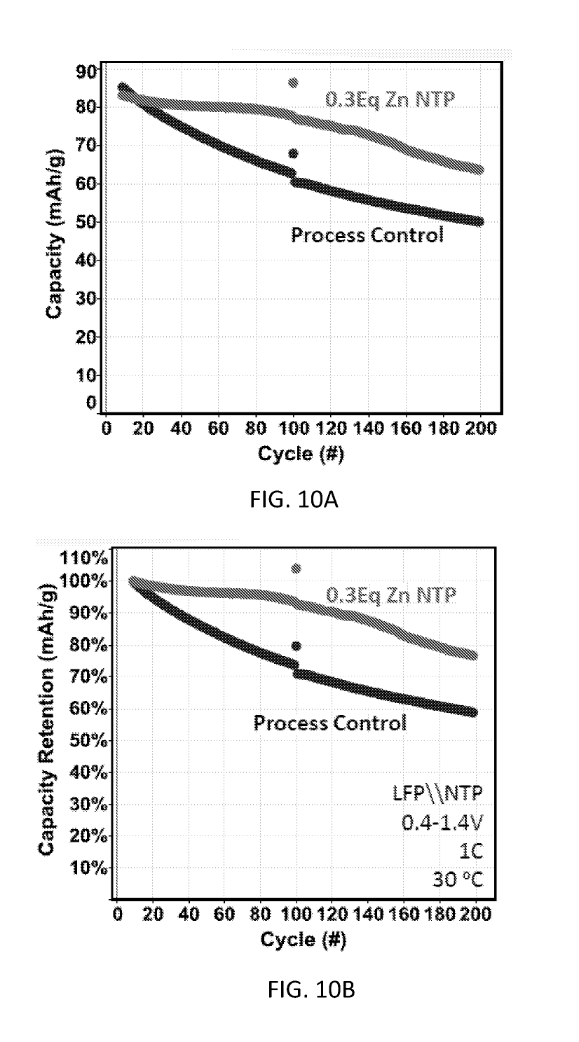

FIG. 10A is a graph illustrating capacities of an exemplary battery cell including NTP doped with about 0.3 M Eq. of zinc, and a process control (i.e., comparative example) battery cell that includes undoped NTP. FIG. 10B is a graph illustrating the capacity retention of the battery cells of FIG. 10A.

Referring to FIG. 10A, the exemplary battery cell exhibited a higher capacity than the process control cell after about 19 cycles, and maintained the higher capacity through 200 cycles. As shown in FIG. 10B, the exemplary battery cell also exhibited significantly better capacity retention after about 19 cycles.

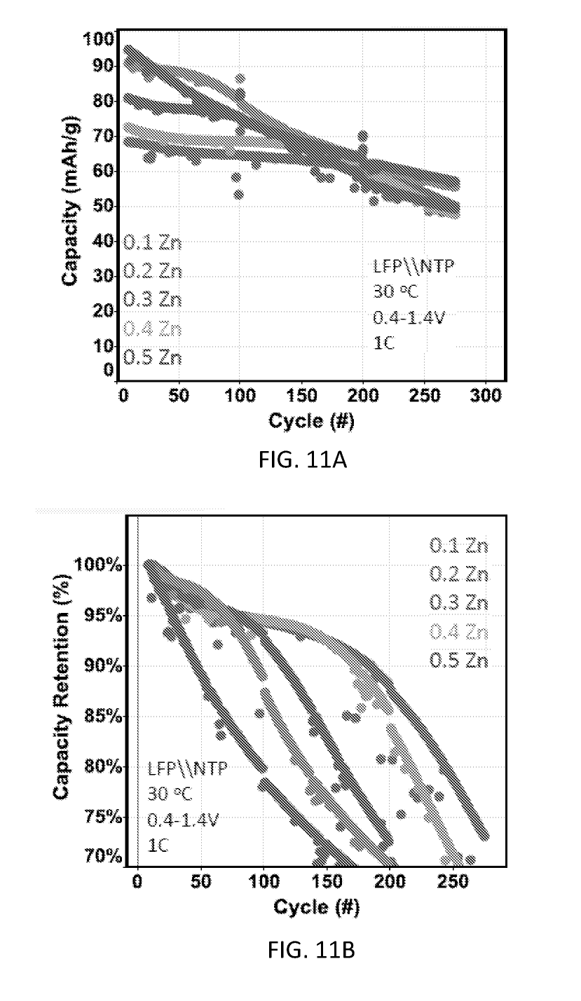

FIGS. 11A and 11B are graphs illustrating the capacity and capacity retention of battery cells including NTP doped with from 0.1 to 0.5 M Eq. amounts of zinc. As can be seen in FIGS. 11A and 11B, increased amounts of zinc generally decreased battery capacity, but also increased capacity retention.

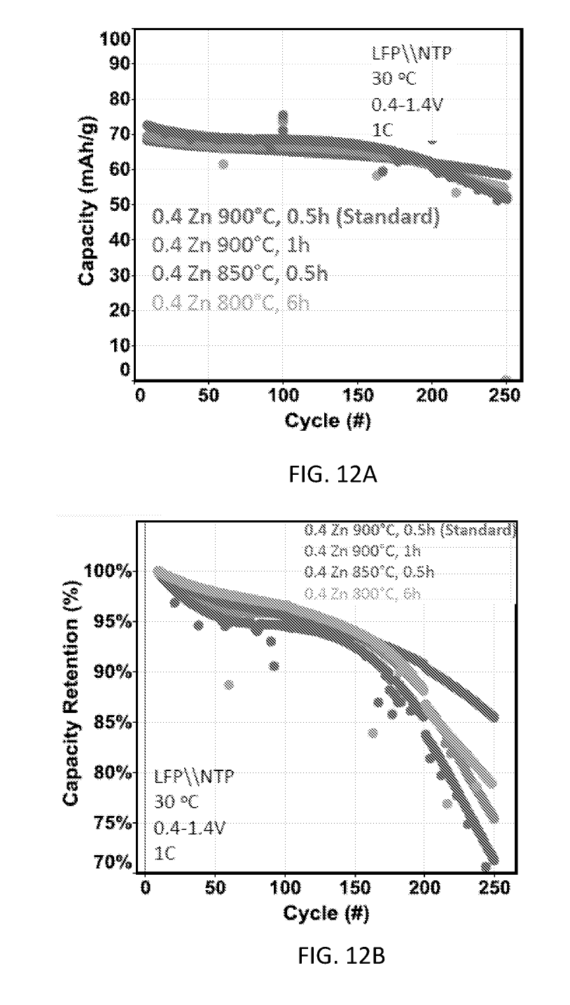

FIGS. 12A and 12B are graphs illustrating the capacity and capacity retention of battery cells including NTP doped with from 0.4 M Eq. of zinc, wherein the anodes underwent a second anneal at time periods ranging from about 0.5 hours to 6 hours, at a temperature ranging from about 850° C. to about 900° C. As can be seen in FIGS. 12A and 12B, all annealing temperatures and durations provided similar improved performance, and annealing at about 850° C. for about 0.5 hours exhibited the highest capacity retention after 250 cycles.

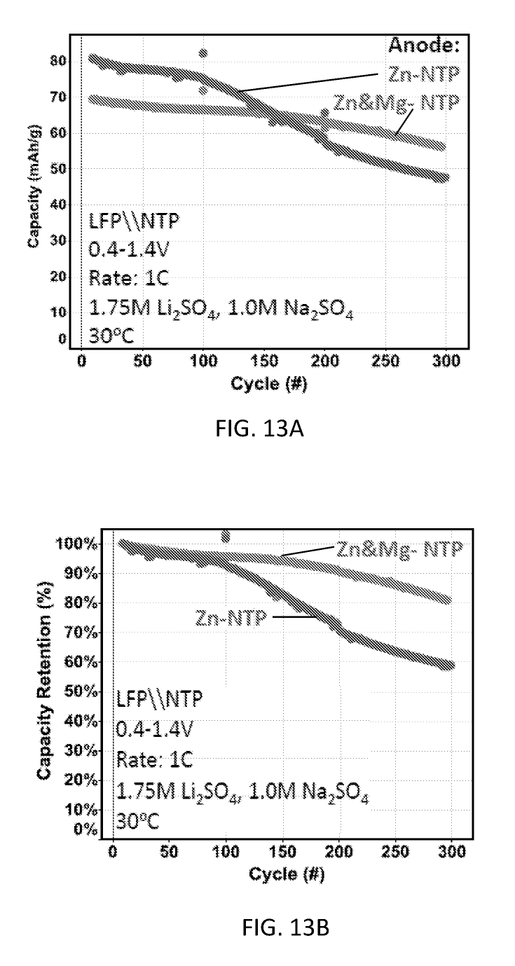

FIGS. 13A and 13B are graphs illustrating the capacity and capacity retention of battery cells including anodes including Zn doped NTP (NaTi_{1.7}Zn_{0.3}(PO₄)₃) and Zn, Mg co-doped NTP (NaTi_{1.4}Zn_{0.3}Mg_{0.3}(PO₄)₃). Referring to FIGS. 13A and 13B, the battery cell including the co-doped NTP material exhibited better capacity after about 160 cycles and better capacity retention, as compared to the battery cell including the Zn doped NTP material.

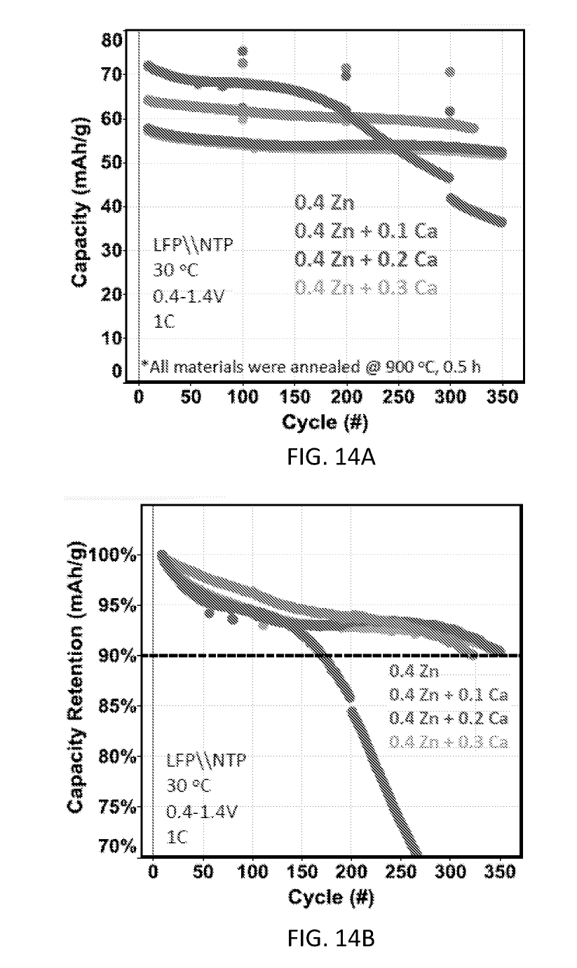

FIGS. 14A and 14B are graphs illustrating the capacity and capacity retention of a battery cell including an anode including NTP doped with Zn only (about 0.4 M Eq.), and battery cells including anodes including NTP co-doped with Zn (about 0.4 M Eq.) and either about 0.1, 0.2, or 0.3 M Eq. of Ca. Referring to FIGS. 14A and 14B, the battery cells including the co-doped NTP material exhibited better capacity after from about 200 to about 250 cycles, and better capacity retention, as compared to the battery cell including the Zn doped NTP material.

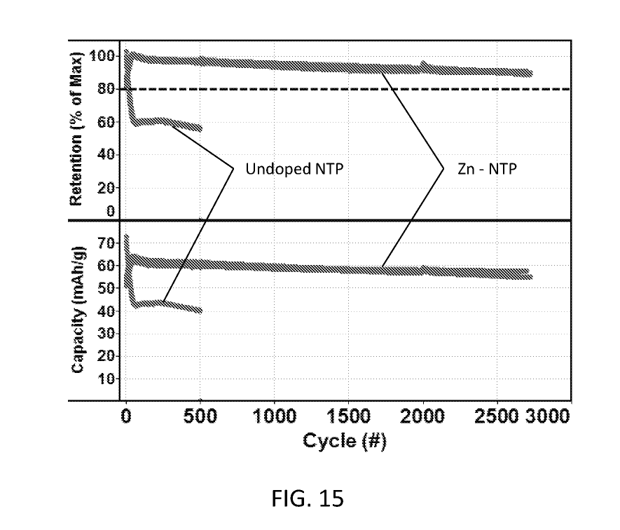

FIG. 15 is a graph illustrating capacity retention as a function of cycle number for a battery cell including an anode including NTP doped with Zn (0.2 M Eq.) and for a comparative battery cell including an anode including undoped NTP. As can be seen in FIG. 15, the battery cell including the Zn-doped anode maintained above 80% its initial capacity (e.g., a capacity over 50 mAh/g) over 2700 charge/cycles. In contrast, the comparative battery cell maintained less than about 60% its initial capacity after fewer than 500 charge/discharge cycles.

Accordingly, the present experimental examples demonstrate that doped and co-doped NTP materials provide unexpected benefits in terms of capacity retention and/or cycle life, as compared to conventional NTP materials.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

1. An anode electrode for an energy storage device comprising a doped active material represented by a formula:
ATi_{2-X}M_{X}(PO₄)₃,
wherein:
A comprises at least 51 atomic percent sodium and 0 to 49 atomic percent alkali metals other than sodium;
X ranges from about 0.1 to about 0.6, and
M is selected from at least one of Mg, Ca, Mn, Mo, Nb, Ni, W, Zn, Zr, Al, Ge, and Si.

2. The electrode of claim 1, wherein A comprises 60 to 100 atomic percent sodium, and 0 to 40 atomic percent lithium.

3. The electrode of claim 2, wherein A consists essentially of sodium and the doped active material comprises doped sodium titanium phosphate having a NASICON structure and represented by a formula NaTi_{2-X}M_{X}(PO₄)₃.

4. The electrode of claim 1, wherein M is selected from the group consisting of at least one of Zn, Ca and Mg.

5. The electrode of claim 1, wherein:
M consists essentially of Zn; and
the doped active material comprises zinc doped sodium titanium phosphate having a NASICON structure and represented by a formula NaTi_{2-X}Zn_{X}(PO₄)₃, wherein X ranges from about 0.2 to about 0.45.

6. (canceled)

7. The electrode of claim 1, wherein:
M consists essentially of Zn and Ca; and
the doped active material comprises zinc and calcium doped sodium titanium phosphate having a NASICON structure and represented by a formula NaTi_{2-(X+Y)}Zn_{X}Ca_{Y}(PO₄)₃, wherein Y ranges from about 0.035 to about 0.3.

8. (canceled)

9. The electrode of claim 1, wherein:
M consists essentially of Zn and Mg; and
the doped active material comprises zinc and manganese doped sodium titanium phosphate having a NASICON structure and represented by a formula NaTi_{2-(X+Y)}Zn_{X}Mg_{Y}(PO₄)₃, wherein Y ranges from about 0.035 to about 0.3.

10. (canceled)

11. The electrode of claim 1, wherein:
M_{X} comprises at least two elements M′ and N;
the doped active material is represented by a formula ATi_{2-(Z+Y)}M′_{Z}N_{Y}(PO₄)₃, wherein Z ranges from about 0.1 to about 0.565 and Y ranges about 0.035 to about 0.3; and
M′ and N comprise different elements selected from Mg, Ca, Mn, Mo, Nb, Ni, W, Zn, Zr, Al, Ge and Si.

12. The electrode of claim 1, further comprising activated carbon mixed with the active material, wherein a mass ratio of the active material to the activated carbon ranges from about 1:9 to about 9:1.

13. The electrode of claim 1, wherein:
the doped active material comprises sodium titanium phosphate having a NASICON structure doped with zinc or a combination of zinc with at least one of calcium and magnesium; and
the doped sodium titanium phosphate active material includes only the sodium, titanium, phosphorus and oxygen of the NASICON structure and a dopant selected from one or more zinc, calcium, magnesium and lithium, and excludes all other elements or compounds above an unavoidable trace impurity level; and
the doped sodium titanium phosphate material excludes halogen and hydroxyl compounds.

14. (canceled)

15. The electrode of claim 1, wherein the doped active material comprises a doped sodium titanium phosphate having a NASICON structure in which dopant atoms are present in the sodium titanium phosphate material throughout a thickness of the anode electrode and not just in a shell or coating on a surface of the anode electrode.

16. The electrode of claim 15, wherein a dopant is selected from one or more zinc, calcium, magnesium and lithium, and excludes all other elements or compounds above an unavoidable trace impurity level.

17. The electrode of claim 1, wherein the electrode is free of polymers, is free of organic materials, or is free of both polymers and organic materials.

18. An energy storage device, comprising:
electrochemical energy storage cells connected electrically in series, wherein each cell comprises:
the anode electrode of claim 1;
a positive cathode electrode comprising a cubic spinel λ-MnO₂-type material; and
an aqueous electrolyte comprising at least one of Na₂SO₄, K₂SO₄, and Li₂SO₄.

19. (canceled)

20. A method of making an anode electrode for an energy storage device comprising:
combining a dopant selected from at least one of elemental Mg, Ca, Mn, Mo, Nb, Ni, W, Zn, Zr, Al, Ge, and Si, an oxide thereof or a hydroxide thereof with titanium, sodium and phosphate precursor materials;
heating the combined dopant and precursor materials to form a doped sodium titanium phosphate material; and
providing the doped sodium titanium phosphate material into an anode electrode of the energy storage device.

21. (canceled)

22. An anode electrode for an energy storage device comprising a doped active material represented by the formula:
Na_{1-X}D_{X}Ti_{2-Y}M_{Y}(P_{1-Z}E_{Z}O₄)₃,
wherein:
X ranges from 0 to about 0.49;
Y ranges from 0 to about 0.6;
Z ranges from 0 to about 0.4;
X+Y+Z>0;
D comprises Li, an alkaline earth metal or a combination thereof;
M comprises an alkaline earth metal, a transition metal, a P-block metal element or any combination thereof; and
E comprises a metalloid.

23. The electrode of claim 22, wherein:
E comprises silicon; and
Z ranges from about 0.1 to about 0.4.

24. The electrode of claim 22, wherein M is selected from the group consisting of Zn, Ca, Mg, or any combination thereof and D is selected from the group consisting of Ca, Mg, Li, or any combination thereof.

25. The electrode of claim 24, wherein:
D comprises at least one of Ca and Mg;
M consists essentially of Zn;
X>0; and
Y ranges from about 0.2 to about 0.45.

26. The electrode of claim 22, wherein X+Y>0 and wherein D comprises two or more of Li or alkaline earth metals.
